(19) United States
(12) Patent Application Publication
(10) Pub. No.: US 2018/0074245 A1
(43) Pub. Date: Mar. 15, 2018

(54) SYSTEMS, DEVICES, AND METHODS FOR CURVED HOLOGRAPHIC OPTICAL ELEMENTS

(71) Applicant: Thalmic Labs Inc., Kitchener (CA)

(72) Inventors: Stefan Alexander, Elmira (CA); Vance R. Morrison, Kitchener (CA); Thomas Mahon, Guelph (CA)

(21) Appl. No.: 15/814,923

(22) Filed: Nov. 16, 2017

Related U.S. Application Data
(63) Continuation of application No. 15/381,883, filed on Dec. 16, 2016.
(60) Provisional application No. 62/268,892, filed on Dec. 17, 2015.

(51) Int. Cl. G02B 5/32; G03H 1/18; G03H 1/04; G02B 27/01; G03H 1/20

(52) U.S. Cl. CPC G02B 5/32; G03H 1/182; G03H 1/0402; G03H 1/0465; G03H 1/181; G02B 27/0172; G03H 2270/21; G02B 2027/0174; G02B 2027/015; G03H 2001/043; G03H 2001/0439; G03H 2001/186; G03H 2260/12; G03H 1/202

(57) ABSTRACT

Systems, devices, and methods for making, replicating, and using curved holographic optical elements (“HOEs”) are described. A hologram may be optically recorded into a planar layer of holographic film with various measures in place to compensate for changes (e.g., in optical power and/or playback wavelength and/or angular bandwidth) that may result when a curvature is subsequently applied thereto. A hologram may be optically recorded into a curved layer of holographic film with various measures in place to compensate for optical effects of a curved transparent substrate upon which the holographic film is mounted. A curved HOE may be returned to a planar configuration to undergo holographic replication or holographic replication may be performed using a curved master HOE and curved “recipient” film. The curved HOEs described herein are particularly well-suited for use when integrated with a curved eyeglass lens to form the transparent combiner of a virtual retina display.

### BACKGROUND

### Technical Field

The present systems, devices, and methods generally relate to curved holographic optical elements and particularly relate to methods of producing curved holograms as well as systems and devices that employ curved holograms.

### Description of the Related Art

### Wearable Heads-Up Displays

A head-mounted display is an electronic device that is worn on a user's head and, when so worn, secures at least one electronic display within a viewable field of at least one of the user's eyes, regardless of the position or orientation of the user's head. A wearable heads-up display is a head-mounted display that enables the user to see displayed content but also does not prevent the user from being able to see their external environment. The “display” component of a wearable heads-up display is either transparent or at a periphery of the user's field of view so that it does not completely block the user from being able to see their external environment. Examples of wearable heads-up displays include: the Google Glass®, the Optinvent Ora®, the Epson Moverio®, and the Sony Glasstron®, just to name a few.

The optical performance of a wearable heads-up display is an important factor in its design. When it comes to face-worn devices, however, users also care a lot about aesthetics. This is clearly highlighted by the immensity of the eyeglass (including sunglass) frame industry. Independent of their performance limitations, many of the aforementioned examples of wearable heads-up displays have struggled to find traction in consumer markets because, at least in part, they lack fashion appeal. Most wearable heads-up displays presented to date employ large display components and, as a result, most wearable heads-up displays presented to date are considerably bulkier and less stylish than conventional eyeglass frames.

A challenge in the design of wearable heads-up displays is to minimize the bulk of the face-worn apparatus will still providing displayed content with sufficient visual quality. There is a need in the art for wearable heads-up displays of more aesthetically-appealing design that are capable of providing high-quality images to the user without limiting the user's ability to see their external environment.

### Photopolymer

A photopolymer is material that changes one or more of its physical properties when exposed to light. The changes may be manifested in different ways, including structurally and/or chemically. Photopolymer materials are often used in holography as the film or medium within or upon which a hologram is recorded. For example, a photopolymer film may be controllably exposed/illuminated with a particular interference pattern of light to cause surface relief patterns to form in/on the photopolymer film, the surface relief patterns conforming to the intensity/phase pattern of the illuminating light. A photopolymer film may comprise only photopolymer material itself, or it may comprise photopolymer carried on or between any or all of: a substrate, such as triacetate and/or polyamide and/or polyimide, and/or a fixed or removable protective cover layer. Many examples of photopolymer film are available in the art today, such as Bayfol® HX film from Bayer AG.

### Eyeglass Lenses

A typical pair of eyeglasses or sunglasses includes two lenses, a respective one of the lenses positioned in front of each eye of the user when the eyeglasses/sunglasses are worn on the user's head. In some alternative designs, a single elongated lens may be used instead of the two separate lenses, the single elongated lens spanning in front of both eyes of the user when the eyeglasses/sunglasses are worn on the user's head. Throughout the remainder of this specification and the appended claims, the terms “eyeglasses” and “sunglasses” are used substantially interchangeably unless the specific context requires otherwise.

The eyeglass lens is the component that provides the main optical function of a pair of eyeglasses. An eyeglass lens is optically transparent, though may optionally provide a degree of tinting and often (though not necessarily) provides some form of optical power. An eyeglass lens may be formed of glass, or a non-glass (e.g., plastic) material such as polycarbonate, CR-39, Hivex®, or Trivex®.

An eyeglass lens may be a non-prescription lens that transmits light essentially unaffected or provides a generic function (such as magnification) to images that pass therethrough. Alternatively, an eyeglass lens may be a prescription lens (usually user-specific) that compensates for deficiencies in the user's vision by imparting specific optical function(s) to transmitted light. Generally, an eyeglass lens begins as a generic lens (or a lens “blank”) and a prescription may optionally be applied by deliberately shaping the curvature on either or both of the outward-facing and/or inward-facing surface of the lens. It is most common for a prescription to be applied by shaping the curvature of the inward-facing surface (i.e., the surface that is most proximate the user's eye when worn) of a lens.

Generally, the vast majority of eyeglass lenses in the art are curved and not planar structures. This curvature is used to impart desired optical properties on light passing therethrough and also enables more natural and better-fitting aesthetic designs for eyeglass frames compared to flat planar lens geometries.

### BRIEF SUMMARY

A method of producing a curved holographic optical element (“HOE”) that comprises at least one hologram recorded in a holographic film, wherein the curved HOE has a total optical power P_{T}, may be summarized as including: positioning and orienting the holographic film in a planar geometry; optically recording a hologram in the holographic film while the holographic film is in the planar geometry, wherein the hologram has a holographic optical power P_{H} that is less than the total optical power P_{T} of the curved HOE; and applying a curvature to the holographic film, wherein applying the curvature to the holographic film includes applying a geometric optical power P_{G} to the holographic film, the geometric optical power P_{G} less than the total optical power P_{T} of the curved HOE, and wherein the total optical power P_{T} of the curved HOE includes an additive combination of the holographic optical power P_{H} and the geometric optical power P_{G} given, at least approximately, by P_{T}=P_{H}+P_{G}. Positioning and orienting the holographic film in a planar geometry may include mounting the holographic film on a planar surface. Optically recording a hologram in the holographic film while the holographic film is in the planar geometry may include optically recording the hologram in the holographic film while the holographic film is mounted on the planar surface. The method may further include removing the holographic film from the planar surface before applying the curvature to the holographic film.

Applying a curvature to the holographic film may include at least one of: mounting the holographic film on a curved surface or embedding the holographic film within a curved volume. Optically recording a hologram in the holographic film while the holographic film is in the planar geometry may include optically recording the hologram in the holographic film with a first laser having a first wavelength while the holographic film is in the planar geometry, the first wavelength different from a playback wavelength of the curved HOE. Applying a curvature to the holographic film may include stretching the holographic film, and optically recording the hologram in the holographic film with a first laser having a first wavelength while the holographic film is in the planar geometry may include optically recording the hologram in the holographic film with the first laser having a first wavelength that is less than the playback wavelength of the curved HOE. Alternatively, applying a curvature to the holographic film may include compressing the holographic film, and optically recording the hologram in the holographic film with a first laser having a first wavelength while the holographic film is in the planar geometry may include optically recording the hologram in the holographic film with the first laser having a first wavelength that is greater than the playback wavelength of the curved HOE.

Optically recording a hologram in the holographic film while the holographic film is in the planar geometry may include optically recording the hologram in the holographic film with a first laser at a first incidence angle while the holographic film is in the planar geometry, the first incidence angle different from a playback incidence angle of the curved HOE.

The total optical power P_{T} of the curved HOE may be positive with a total focal length f_{T}. Optically recording a hologram in the holographic film while the holographic film is positioned and oriented in the planar geometry may include optically recording a hologram having a positive holographic optical power P_{H} and a first focal length f_{H} that is greater than the total focal length f_{T} of the curved HOE. Applying a curvature to the holographic film may include applying a positive geometric optical power P_{G} having a second focal length f_{G} to the holographic film, the second focal length f_{G} greater than the total focal length f_{T} of the curved HOE, wherein the total focal length f_{T} of the curved HOE includes an additive reciprocal combination of the first focal length f_{H} and the second focal length f_{G} given, at least approximately, by 1/f_{T}=1/f_{H}+1/f_{G}.

A curved HOE having a total optical power P_{T} may be summarized as including: at least one curved layer of holographic film that includes at least one hologram, wherein: the at least one hologram has a holographic optical power P_{H} that is less than the total optical power P_{T} of the curved HOE; and the at least one curved layer of holographic film has a geometric optical power P_{G} that is less than the total optical power P_{T} of the curved HOE, and wherein the total optical power P_{T} of the curved HOE includes an additive combination of the holographic optical power P_{H} of the at least one hologram and the geometric optical power P_{G} of the at least one curved layer of holographic film given, at least approximately, by P_{T}=P_{H}+P_{G}. The total optical power P_{T} of the curved HOE may be positive and include a total focal length f_{T}. The holographic optical power P_{H} of the at least one hologram may be positive and have a first focal length f_{H} that is greater than the total focal length f_{T} of the curved HOE. The geometric optical power P_{G} of the at least one curved layer of holographic film may be positive and have a second focal length f_{G} that is greater than the total focal length f_{T} of the curved HOE, wherein the total focal length f_{T} of the curved HOE includes an additive reciprocal combination of the first focal length f_{H} and the second focal length f_{G} given, at least approximately, by 1/f_{T}=1/f_{H}+1/f_{G}.

A method of producing a curved HOE that comprises at least one hologram recorded in a holographic film may be summarized as including: positioning and orienting the holographic film in a planar geometry; optically recording a hologram in the holographic film with a first laser having a first wavelength while the holographic film is in the planar geometry, the first wavelength different from a playback wavelength of the curved HOE; and applying a curvature to the holographic film. Applying a curvature to the holographic film may include stretching the holographic film, and optically recording the hologram in the holographic film with a first laser having a first wavelength while the holographic film is in the planar geometry may include optically recording the hologram in the holographic film with the first laser having a first wavelength that is less than the playback wavelength of the curved HOE. Alternatively, applying a curvature to the holographic film may include compressing the holographic film, and optically recording the hologram in the holographic film with a first laser having a first wavelength while the holographic film is in the planar geometry may include optically recording the hologram in the holographic film with the first laser having a first wavelength that is greater than the playback wavelength of the curved HOE.

Optically recording a hologram in the holographic film while the holographic film is in the planar geometry may include optically recording the hologram with a holographic optical power P_{H} that is less than a total optical power P_{T} of the curved HOE while the holographic film is in the planar geometry. Applying a curvature to the holographic film may include applying a geometric optical power P_{G} that is less than the total optical power P_{T} of the curved HOE to the holographic film, and the total optical power P_{T} of the curved HOE may include an additive combination of the holographic optical power P_{H} and the geometric optical power P_{G} given, at least approximately, by P_{T}=P_{H}+P_{G}.

Positioning and orienting the holographic film in a planar geometry may include mounting the holographic film on a planar surface. Optically recording a hologram in the holographic film with a first laser having a first wavelength while the holographic film is in the planar geometry may include optically recording the hologram in the holographic film with the first laser having the first wavelength while the holographic film is mounted on the planar surface. The method may further include removing the holographic film from the planar surface before applying the curvature to the holographic film. Applying a curvature to the holographic film may include at least one of: mounting the holographic film on a curved surface or embedding the holographic film within a curved volume.

A method of producing a HOE that comprises at least one hologram recorded in a holographic film may be summarized as including: providing a first layer of holographic film in a planar geometry; stretching the first layer of holographic film; optically recording a hologram in the first layer of holographic film while the first layer of holographic film is stretched; and returning the first layer of holographic film to an unstretched state. Stretching the first layer of holographic film may include mounting the first layer of holographic film onto a curved surface. The method may further include at least one of: mounting the first layer of holographic film on a curved surface for playback; or embedding the first layer of holographic film within a curved volume for playback. Mounting the first layer of holographic film on a curved surface for playback may include stretching the first layer of holographic film in the direction normal to a plane of the first layer of holographic film onto the curved surface.

The method may further include: providing a second layer of holographic film in a planar geometry; replicating the hologram from the first layer of holographic film in the second layer of holographic film while both the first layer of holographic film and the second layer of holographic film are each in respective unstretched states; and at least one of: mounting the second layer of holographic film on a curved surface for playback or embedding the second layer of holographic film within a curved volume for playback. Mounting the second layer of holographic film on a curved surface for playback may include stretching the second layer of holographic film in a direction normal to a plane of the second layer of holographic film onto the curved surface.

A method of producing a curved HOE may be summarized as including: mounting a holographic film on a first surface, the first surface being transparent and having a first curvature; and optically recording a hologram in the holographic film while the holographic film is mounted on the first surface. The method may further include: removing the holographic film from the first surface; and at least one of: mounting the holographic film on a second surface for playback, the second surface having a second curvature substantially equal to the first curvature; or embedding the holographic film within a curved volume for playback, the curved volume having a second curvature substantially equal to the first curvature.

A method of replicating a curved HOE that comprises at least one hologram recorded in a holographic film may be summarized as including: providing a first layer of holographic film; mounting the first layer of holographic film on a first surface, the first surface having a first curvature; optically recording a hologram in the first layer of holographic film while the first layer of holographic film is mounted on the first surface; providing a second layer of holographic film; applying the first curvature to the second layer of holographic film; and replicating the hologram from the first layer of holographic film in the second layer of holographic film while both the first layer of holographic film and the second layer of holographic film each have the first curvature.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements, and have been solely selected for ease of recognition in the drawings.

FIG. 1 is a flow-diagram showing an exemplary method of producing a curved holographic optical element (“HOE”) that has a total optical power and comprises at least one hologram recorded in a holographic film in accordance with the present systems, devices, and methods.

FIG. 2 is an illustrative diagram showing the difference between holographic optical power and geometric optical power, and how the two combine to produce total optical power in accordance with the present systems, devices, and methods.

FIG. 3 is an illustrative diagram showing exemplary effects on the spacing between elements of the interference pattern that encodes a hologram when a curvature is applied to the corresponding holographic film by i) stretching and ii) compressing the holographic film in accordance with the present systems, devices, and methods.

FIG. 4 is a flow-diagram showing an exemplary method of producing a curved HOE that comprises at least one hologram recorded in a holographic film in accordance with the present systems, devices, and methods.

FIG. 5 is a flow-diagram showing an exemplary method of producing a HOE that comprises at least one hologram recorded in a holographic film in accordance with the present systems, devices, and methods.

FIG. 6 is a flow-diagram showing an exemplary method of producing a curved HOE in accordance with the present systems, devices, and methods.

FIG. 7 is a flow-diagram showing an exemplary method of replicating a curved HOE that comprises at least one hologram recorded in a holographic film in accordance with the present systems, devices, and methods.

FIG. 8 is a sectional view of an exemplary curved HOE in accordance with the present systems, devices, and methods.

FIG. 9 is a sectional view of another exemplary curved HOE in accordance with the present systems, devices, and methods.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with head-mounted displays and electronic devices have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its broadest sense, that is as meaning “and/or” unless the content clearly dictates otherwise.

The headings and Abstract of the Disclosure provided herein are for convenience only and do not interpret the scope or meaning of the embodiments.

The various embodiments described herein provide systems, devices, and methods for curved holographic optical elements (“HOEs”). In the art, HOEs are generally recorded and played back in a planar configuration. However, certain applications (e.g., the virtual retina display (“VRD”) architectures described in U.S. Provisional Patent Application Ser. No. 62/242,844 (now U.S. Non-Provisional patent application Ser. No. 15/147,638), U.S. Provisional Patent Application Ser. No. 62/156,736 (now U.S. Non-Provisional patent application Ser. No. 15/145,576, US Patent Application Publication No. 2016-0327797, and US Patent Application Publication No. 2016-0327796), and/or U.S. Provisional Patent Application Ser. No. 62/117,316 (now U.S. Non-Provisional patent application Ser. No. 15/046,234, U.S. Non-Provisional patent application Ser. No. 15/046,254, and US Patent Application Publication No. 2016-0238845)), are better-suited to the use of curved HOEs. The various embodiments described herein provide processes for optically recording and, in some cases, replicating HOEs that are designed to be played back in a curved geometry. The various embodiments described herein also provide curved HOEs that have been prepared by such processes.

A conventional HOE is recorded on a planar surface and maintained in a planar configuration for playback. U.S. Provisional Patent Application Ser. No. 62/214,600 (now U.S. Non-Provisional patent application Ser. No. 15/256,148) describes systems, devices, and methods for the physical integration of a HOE with a curved eyeglass lens in order to produce the transparent combiner of a VRD architecture that has an eyeglasses form factor, such as the VRD architectures described above. The physical integration of a planar HOE with a curved eyeglass lens can, in some implementations, result in a curvature being applied to the HOE itself. This curvature can impact the optical characteristics and playback performance of the HOE. There is a need in the art for HOEs, and methods of making HOEs, that can perform in designed ways when mounted on or within curved surfaces.

Throughout this specification and the appended claims, the term HOE is generally used to describe a structure that embodies, encodes, or otherwise includes at least one hologram recorded, embedded, integrated, or otherwise included therein and/or thereon. A single HOE may include one or multiple layer(s) of holographic film (such as silver halide or a photopolymer film such as Bayfol® HX film from Bayer AG) carrying one or multiple hologram(s). A person of skill in the art will appreciate that an HOE may also include one or more layer(s) of other material(s), such as a hard coating, an anti-reflective coating, an adhesive layer, and so on.

Throughout this specification and the appended claims, the term “playback” (and variants such as “played back”) is generally used to refer to the process of viewing, activating, or otherwise optically using a HOE after recording. Similarly, the term “playback light” is generally used to refer to light that is used to activate or view the hologram during playback (as distinct from, for example, “recording light,” which is light that is used to record the hologram).

Throughout this specification and the appended claims, various references are made to “curved holograms/HOEs” and “holograms/HOEs that are designed to be played back in a curved geometry.” Generally, a layer of holographic film has two faces (a front face and a rear face) each having the same area separated from one another by a thickness, and a curved hologram/HOE is one that has a physical curvature over its area (or faces) such that the area (or faces) of the holographic film is (or are) not flat or planar. In other words, if the a face of a planar holographic film forms a plane in the x- and y-dimensions (i.e., an xy-plane), then curvature will give the face a varying z-dimension as well. The curvature may be homogeneous, such as cylindrical or spherical, or it may be heterogeneous. A curved hologram/HOE may be designed to be played back in a curved geometry, but a hologram/HOE that is designed to be played back in a curved geometry need not necessarily be curved at all times. For example, some embodiments described herein provide holograms/HOEs that are recorded in a planar geometry but are designed to account for effects that will arise when a curvature is subsequently applied to the hologram/HOE and the hologram/HOE is played back while curved. Such a hologram/HOE is characterized herein as a hologram/HOE that is “designed to be played back in a curved geometry” but may exist in a planar state during recording and for some time afterwards, until a curvature is applied to thereto, at which point it becomes a “curved hologram/HOE.”

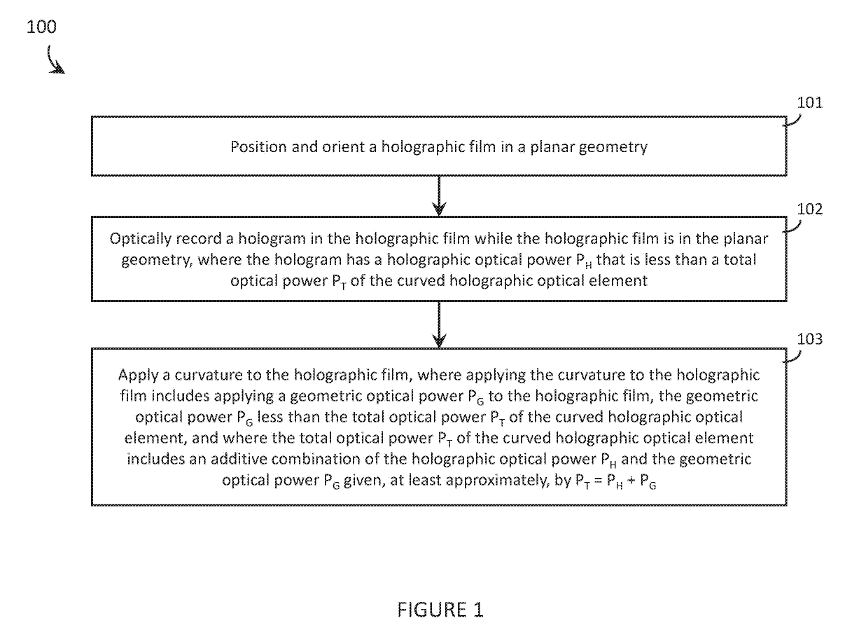

FIG. 1 is a flow-diagram showing an exemplary method 100 of producing a curved HOE that has a total optical power and comprises at least one hologram recorded in a holographic film in accordance with the present systems, devices, and methods. Method 100 includes three acts 101, 102, and 103, though those of skill in the art will appreciate that in alternative embodiments certain acts may be omitted and/or additional acts may be added. Those of skill in the art will also appreciate that the illustrated order of the acts is shown for exemplary purposes only and may change in alternative embodiments.

At 101, at least one layer of holographic film is positioned and oriented in a planar geometry. This may be accomplished by, for example, mounting the at least one layer of holographic film on a planar surface, which may include laminating, adhering, gluing, or otherwise applying the holographic film (e.g., using mechanical fixtures to hold the holographic film in place) to the planar surface with any number (including zero) of intermediate layers. The planar surface may advantageously be optically transparent and, if one or more intermediate layer(s) is/are included, such layer(s) should advantageously also be optically transparent. As an example, the planar surface may be an optically clear substrate (e.g., plastic or glass) suitable for use in optical recording of holograms. Being mounted on a planar surface, the holographic film is necessarily in a planar geometry. As alternatives to mounting the holographic film on a planar substrate, the holographic film may be positioned and oriented in a planar geometry by, for example, hanging or suspending the holographic film. In some implementations, the holographic film may already exist in a planar geometry, in which case mounting to a planar surface may not be required.

At 102, a hologram is optically recorded in the holographic film while the holographic film is in the planar geometry (e.g., while the holographic film is mounted on a planar surface). The hologram has a holographic optical power that is less than the total optical power of the curved HOE. In other words, the hologram may be designed so that during playback the hologram may apply an optical function (given by the holographic optical power) to playback light and cause the playback light to focus to a point at a first focal length. Whether the point to which the holographic optical power causes the playback light to focus is in front of or behind the hologram depends on the design of the hologram (i.e., whether the optical power is positive or negative). Throughout this specification and the appended claims, the term “holographic optical power” is generally used to refer to an optical power or optical function imparted on incident light by the interference pattern of a hologram during playback.

At 103, a curvature is applied to the holographic film resulting in a curved holographic film. By applying the curvature to the holographic film, a geometric optical power that is less than the total optical power of the curved HOE is applied to the holographic film. In other words, applying a curvature to the holographic film imparts a “geometric optical power” on the holographic film that is independent of the hologram recorded in the film. During playback, this geometric optical power may cause the playback light to focus to a point at a second focal length. Whether the point to which the geometric optical power causes the playback light to focus is in front of or behind the holographic film depends on the direction of curvature of the holographic film. Throughout this specification and the appended claims, the term “geometric optical power” is generally used to refer to an optical power or an optical function imparted on incident light by the geometry of a holographic film. For the purposes of the present systems, devices, and methods, holographic optical power and geometric optical power are two distinct and independent optical functions that may be imparted on incident light during playback of a curved HOE; however a person of skill in the art will appreciate that, in the case of an otherwise transparent holographic film, at least one hologram may need to be present in the holographic film to influence the incident playback light and cause the geometric optical power to have any effect.

A total optical power (P_{T}) of the curved HOE includes an additive combination of the holographic optical power (P_{H}) and the geometric optical power (P_{G}) given, at least approximately, by:

P_{T}±P_{H}+P_{G}

While the combination of the holographic optical power P_{H} and geometric optical power P_{G} towards the total optical power P_{T} is generally additive as shown above, the phrase “at least approximately” is used to allow for other, additional contributing factors (e.g., a refractive index, if applicable) that may influence the total optical power P_{T} of the curved HOE (e.g., P_{T}=P_{H}+P_{G}+x, where x is a catch-all optical power representing the influence of all other potential contributing factors). Quantitatively, the phrase “at least approximately” should generally be interpreted herein as “plus or minus 10%.”

Similarly, the total focal length (f_{T}=1/P_{T}) of the curved HOE includes an additive reciprocal combination of the first focal length associated with the holographic optical power (f_{H}=1/P_{H}) and the second focal length associated with the geometric optical power (f_{G}=1/P_{G}) given, at least approximately, by:

$$\frac{1}{{f}_{T}} = \frac{1}{{f}_{H}} + \frac{1}{{f}_{G}}$$

In the same way as for the combination of the optical powers, the combination of the first focal length f_{H} and the second focal length f_{G} towards the total focal length f_{T} is generally additive reciprocal, but the phrase “at least approximately” is used to all for other, additional contributing factors that may influence the total focal length f_{T} (e.g., the convergence/divergence/collimation of the incident playback light).

Applying a curvature to the holographic film at 103 may or may not include mounting the holographic film on a curved surface (such as, for example, integrating the HOE with a curved eyeglass lens as described in U.S. Provisional Patent Application Ser. No. 62/214,600, now U.S. Non-Provisional patent application Ser. No. 15/256,148) or embedding the holographic film within a curved volume. Generally, throughout this specification and the appended claims the phrase “mounting on a surface” (and variants, such as “mounted on a surface”) is used loosely to refer to any integration between the holographic film and a surface. As examples, “mounting on a surface” may include, without limitation: laminating, adhering, gluing, or otherwise applying the holographic film to the surface or supporting of the holographic film by the surface whether adhered to or not.

As an alternative to applying curvature to a holographic film by mounting it on a curved surface, a holographic film may be embedded within a curved volume (as also described in U.S. Provisional Patent Application Ser. No. 62/214,600, now U.S. Non-Provisional patent application Ser. No. 15/256,148). In this case, curvature may be applied to the holographic film as part of the embedding process, or the holographic film may be formed to embody a curvature (e.g., using known techniques for film shaping, such as gas flow, a pressure differential on opposite sides of the film, and the like) prior to being embedded in the curved volume. The embedding itself may employ a casting or injection molding process.

In implementations in which act 101 involves mounting the holographic film to a planar surface, method 100 may further include (in between acts 102 and 103), removing the holographic film from the planar surface. Removing the holographic film from the planar surface may include delaminating, decoupling, or generally disengaging the holographic film from the planar surface.

In conventional hologram design, a hologram is designed to be played back in a planar geometry and geometric optical power is not a design element. In accordance with the present systems, devices, and methods, a HOE that is recorded in a planar geometry (e.g., at 102) but intended for playback in a curved geometry may be designed to compensate for the geometric optical power that will be added to the total optical power of the HOE when the curvature is applied to the HOE (e.g., at 103). For example, if it is desired that an HOE have a total optical power of X when played back in a curved geometry, the HOE may be recorded with a holographic optical power of Y (where Y≠X) to compensate for the geometric contribution to the total optical power that will be applied when the HOE is curved. The holographic optical power of a hologram may be controlled by, among other things, varying a distance between either or both of the sources of laser light used to record the hologram from the holographic film itself. More specifically, for planar playback the hologram may be recorded with the holographic film in a planar geometry and with the two lasers used to record the hologram (e.g., the illumination or object beam and the reference beam) each positioned at a respective point (i.e., a respective “construction point”) p₁ and p₂, where construction point p₁ is separated from the holographic film by a first distance d₁ and construction point p₂ is separated from the holographic film by a second distance d₂. This will result in a holographic optical power of P_{H}. In order to adapt such a hologram for use in a curved geometry (i.e., in order to account for the geometric optical power P_{G} that will be introduced if the hologram is subsequently used in a curved geometry), the construction points p₁ and p₂ may be moved in order to increase/decrease the distances d₁ and d₂ and thereby decrease/increase the holographic optical power P_{H} such that the additive combination of the holographic optical power P_{H} and the geometric optical power P_{G} gives the desired total optical power P_{T} when the hologram is played back in a curved geometry.

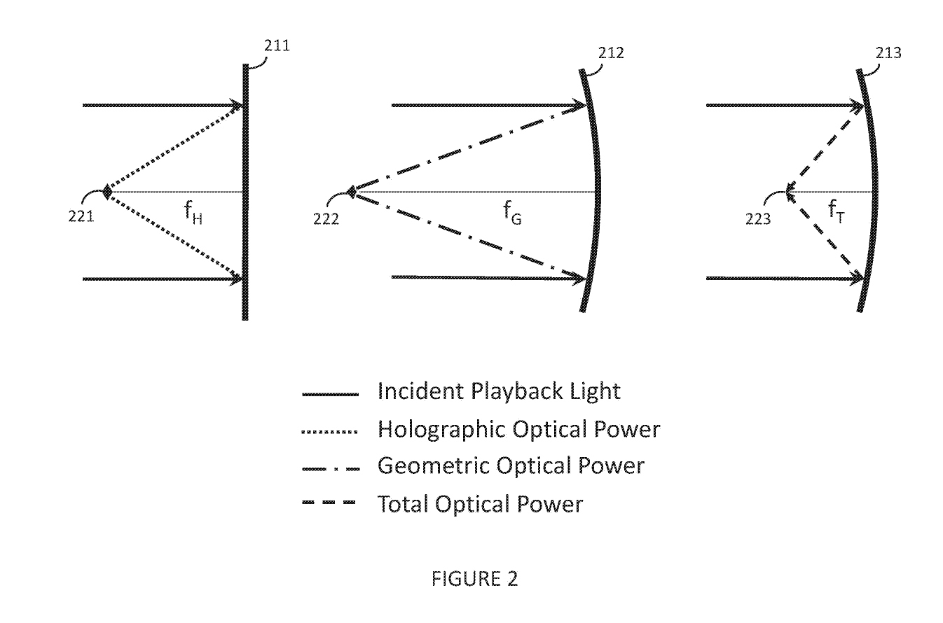

FIG. 2 is an illustrative diagram showing the difference between holographic optical power and geometric optical power, and how the two combine to produce total optical power in accordance with the present systems, devices, and methods. For the purpose of comparison, FIG. 2 includes an illustration of a planar HOE 211, a curved piece of holographic film 212 with a hologram designed to act like a simple mirror, and a curved HOE 213 that corresponds to planar HOE 211 with the curvature of film 212 applied thereto.

Planar HOE 211 includes a hologram having a holographic optical power that functions like a converging mirror to reflect and converge light during playback. Incident playback light impinging on planar HOE 211 is shown converging to a first focal point 221 at a first focal length f_{H} in front of planar HOE 211, and this convergence is solely due to holographic optical power.

For exemplary purposes, curved piece of holographic film 212 includes a hologram that simply reflects incident playback light. In other words, if curved holographic film 212 was not curved, but instead was planar, then curved holographic film 212 would behave like a plane mirror. Curved piece of holographic film 212 has a concave curvature with respect to the incident playback light. Accordingly, curved film 212 has a geometric optical power and incident playback light impinging thereon is shown converging to a second focal point 222 at a second focal length f_{G} in front of curved film 212. This convergence is solely due to geometric optical power.

Curved HOE 213 represents planar HOE 211 after the curvature of film 212 has been applied thereto. In other words, curved HOE 213 represents a curved HOE prepared by a process comprising acts 101, 102, and 103 of method 100. Curved HOE 213 comprises at least one curved layer of holographic film that has a total optical power given by an additive combination of the holographic optical power of planar HOE 211 and the geometric optical power of curved film 212. Accordingly, incident playback light that impinges on curved HOE 213 converges to a third focal point 223 at a third focal length (i.e., the total focal length) f_{T} in front of curved HOE 213, where the total focal length f_{T} of curved HOE 213 (i.e., the third focal length) is given by an additive reciprocal combination of the first focal length f_{H} of planar HOE 211 and the second focal length f_{G} of curved film 212.

Returning to FIG. 1 and method 100, optically recording a hologram in the holographic film while the holographic film is in the planar geometry at 102 may include optically recording the hologram in the holographic film with a first laser having a first wavelength while the holographic film is in the planar geometry. The first wavelength may be deliberately different from a desired playback wavelength of the curved HOE in order to compensate for changes that may occur to the geometry and/or spacing of the interference pattern that encodes the hologram when curvature is applied to the holographic film at 103.

For example, applying curvature to the holographic film at 103 may include stretching the holographic film which may cause an increase in the spacing between at least some of the elements of the interference pattern that encodes the hologram. During playback, a hologram is generally responsive to (i.e., active for) a narrow range of wavelengths of incident playback light (i.e., the “playback wavelength”), particularly the range of wavelengths that are equal to and within a range of the size of the spacing between elements in the interference pattern that encodes the hologram. An increase in the spacing between elements of the interference pattern that encodes the hologram may cause the hologram to become responsive to/active for a range of playback light wavelengths that differs from the range of wavelengths used to record the hologram. In accordance with the present systems, devices, and methods, if a hologram is recorded in a planar geometry but it is known that a curvature is subsequently going to be applied to the holographic film by stretching the hologram, then the hologram may be recorded in the planar geometry using a first wavelength of laser light that is deliberately less than the intended playback wavelength in order to compensate for the increase in the spacing between the elements of the interference pattern that will result when the holographic film is stretched.

Similarly, applying curvature to the holographic film at 103 may include compressing, scrunching, squeezing, or otherwise constricting the holographic film. For example, applying a curvature to the holographic film may involve heating the holographic film and this heating may cause the holographic film to shrink. Throughout this specification and the appended claims, the term “compress” (and variants such as “compressing” and “compression”) is generally used to refer to all means by which the holographic film may reduce in size when curvature is applied. Such compression may cause a decrease in the spacing between at least some of the elements of the interference pattern that encodes the hologram. In accordance with the present systems, devices, and methods, if a hologram is recorded in a planar geometry but it is known that a curvature is subsequently going to be applied to the holographic film by compressing the hologram, then the hologram may be recorded using a first wavelength of laser light that is deliberately greater than the intended playback wavelength in order to compensate for the decrease in the spacing between the elements of the interference pattern that will result when the holographic film is compressed.

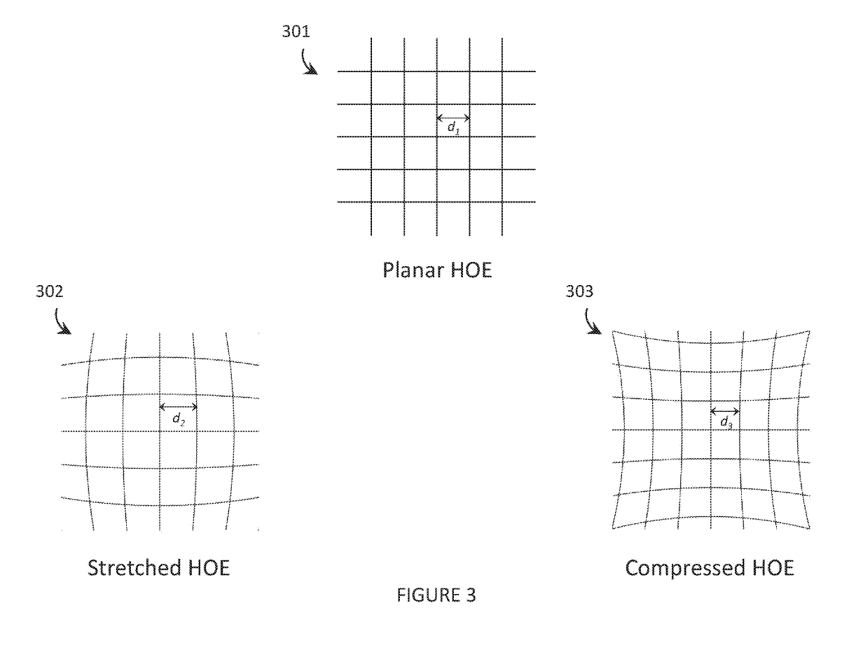

FIG. 3 is an illustrative diagram showing exemplary effects on the spacing between elements of the interference pattern that encodes a hologram when a curvature is applied to the corresponding holographic film by i) stretching and ii) compressing the holographic film in accordance with the present systems, devices, and methods. For the purpose of comparison, FIG. 3 includes an illustration of a planar HOE 301 in its planar geometry alongside the same planar HOE with a curve applied by stretching (i.e., stretched HOE 302) and the same HOE with a curve applied by compressing (i.e., compressed HOE 303). In each illustration, the interference pattern that encodes the hologram is represented by a simple grid for ease of illustration.

For planar HOE 301, the interference pattern is a simple right-angle grid with uniform spacing d₁ in between elements. Accordingly, planar HOE 301 will playback as desired for playback light having a wavelength of ˜d₁, which is substantially equal to the wavelength of the laser light used to record planar HOE 301.

For stretched HOE 302, the same holographic film from planar HOE 301 has a curvature applied (per 103 of method 100; i.e., after recording the hologram in a planar geometry) by stretching the holographic film (e.g., stretching the holographic film onto or against a curved surface, either concave or convex, or using other known techniques for film shaping such as a pressure differential across the film as a membrane). This stretching causes an increase in the spacing between at least some elements of the interference pattern from d₁ to d₂, where d₂ is greater than d₁. Accordingly, stretched HOE 302 will play back as desired for playback light having a wavelength ˜d₂>d₁, which is greater than the wavelength of the laser light used to record planar HOE 301. In accordance with the present systems, devices, and methods, the hologram in stretched HOE 302 may be optically recorded while the holographic film is in a planar geometry using laser light having a wavelength that is less than the wavelength of the light that will be used for playback when stretched HOE 302 is stretched, in order to compensate for the increase in spacing from d₁ to d₂ between interference pattern elements that may result when the holographic film is stretched.

For compressed HOE 303, the same holographic film from planar HOE 301 has a curvature applied (per 103 of method 100; i.e., after recording the hologram in a planar geometry) by compressing or otherwise constricting the holographic film (e.g., squashing the holographic film onto or against a curved surface, either concave or convex). This compressing causes a decrease in the spacing between at least some elements of the interference pattern from d₁ to d₃, where d₃ is less than d₁. Accordingly, compressed HOE 303 will playback as desired for playback light having a wavelength ˜d₃<d₁, which is less than the wavelength of the laser light used to record planar HOE 301. In accordance with the present systems, devices, and methods, the hologram in compressed HOE 303 may be optically recorded while the holographic film is in a planar geometry using laser light having a wavelength that is greater than the wavelength of the light that will be used for playback when compressed HOE 302 is compressed, in order to compensate for the decrease in spacing from d₁ to d₃ between interference pattern elements that may result when the holographic film is compressed.

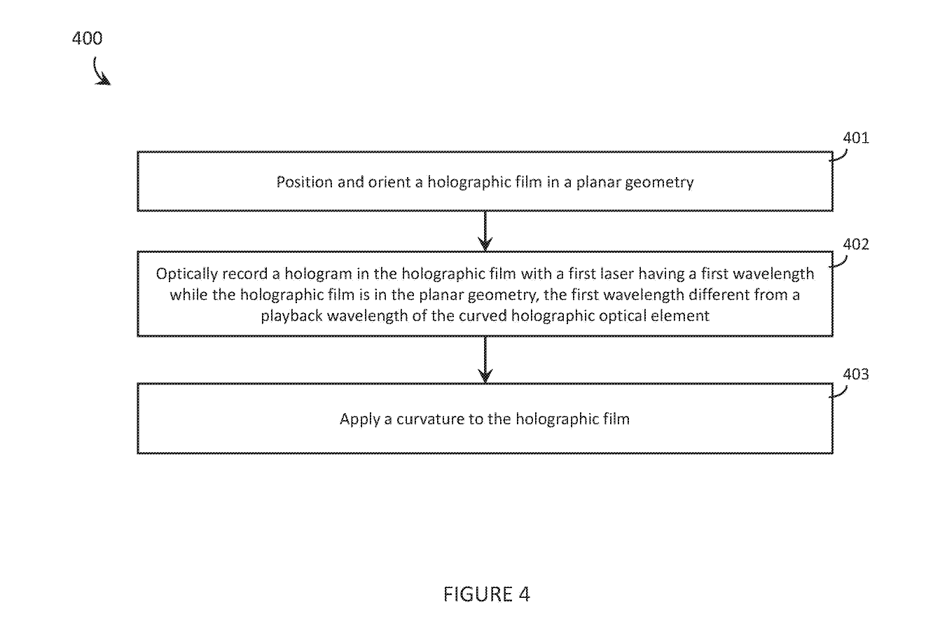

FIG. 4 is a flow-diagram showing an exemplary method 400 of producing a curved HOE that comprises at least one hologram recorded in a holographic film in accordance with the present systems, devices, and methods. Method 400 includes three acts 401, 402, and 403, though those of skill in the art will appreciate that in alternative embodiments certain acts may be omitted and/or additional acts may be added. Those of skill in the art will also appreciate that the illustrated order of the acts is shown for exemplary purposes only and may change in alternative embodiments.

At 401, at least one layer of holographic film is positioned and oriented in a planar geometry in a substantially similar way to that described at 101 of method 100. For example, the at least one layer of holographic film may be mounted on a planar surface. The planar surface may be an optically transparent substrate (e.g., plastic or glass) suitable for use in optical recording of holograms. Being mounted on a planar surface, the holographic film is necessarily in a planar geometry.

At 402, a hologram is optically recorded in the holographic film while the holographic film is in the planar geometry. A first laser having a first wavelength (i.e., a first narrow band range of wavelengths) is used to optically record the hologram while the holographic film is in the planar geometry, and this first wavelength is deliberately different from an intended playback wavelength of the curved HOE. As described previously, the difference between the first wavelength of the recording laser and the playback wavelength is designed to compensate for physical changes to the spacing between elements of the interference pattern that defines the hologram when the holographic film is subsequently curved via stretching or compression.

At 403, a curvature is applied to the holographic film. Applying the curvature includes stretching or compressing the hologram and thereby causing a change in the spacing between at least some elements of the interference pattern that defines the hologram optically recorded at 402 while the holographic film was in a planar geometry. As described previously, when applying curvature to the holographic film includes stretching the holographic film then the first wavelength of laser light used to optically record the hologram at 402 may be less than the intended playback wavelength of the curved HOE in order to compensate for an increase in the spacing between elements of the hologram interference pattern caused by the stretching. As also described previously, when applying curvature to the holographic film includes compressing the holographic film then the first wavelength of laser light used to optically record the hologram at 402 may be greater than the intended playback wavelength of the curved HOE in order to compensate for a decrease in the spacing between elements of the hologram interference pattern caused by the compression.

As in method 100, optically recording a hologram in the holographic film at 402 may include optically recording the hologram with a holographic optical power and a first focal length while the holographic film is in the planar geometry. Furthermore, applying the curvature to the holographic film at 403 may include applying a geometric optical power with a second focal length to the holographic film. As before, the holographic optical power and the geometric optical power may both be less than the total optical power of the curved HOE. The total optical power of the curved HOE may include an additive combination of the holographic optical power and the geometric optical power while a total focal length of the curved HOE may include an additive reciprocal combination of the first focal length and the second focal length.

Wavelength is an example of a property of recording laser light that can influence the spacing between elements in the interference pattern that encodes, embodies, or otherwise represents a hologram in holographic film. Another example of such a property is the angle of incidence of the recording laser light. How exactly the angle of incidence of the recording light can influence (e.g., compensate for subsequent changes resulting from stretching/shrinking the holographic film) the spacing between elements in the interference pattern depends a lot on the specific implementation. For example, for a fixed wavelength of recording light, the spacing between elements in the interference pattern of a hologram may, in some implementations, increase as the angle of incidence of the recording light moves away from normal. Thus, if applying a curvature to a holographic film is going to involve stretching the holographic film, a steeper (i.e., closer to normal) angle of incidence for the recording light may be used while the holographic film is in a planar geometry, compared to what would be used if the hologram was intended to be played back without applying curvature. The steeper angle of incidence for the recording light may produce a smaller distance between elements in the interference pattern, but the subsequent stretching when the curvature is applied may further separate such elements to ultimately produce the desired spacing for playback while curved. Likewise, if applying a curvature to a holographic film is going to involve compressing the holographic film, a flatter (i.e., further from normal) angle of incidence for the recording light may be used while the holographic film is in a planar geometry, compared to what would be used if the hologram was intended to be played back without applying curvature. The flatter angle of incidence for the recording light may produce a larger distance between elements in the interference pattern, but the subsequent compressing when the curvature is applied may bring such elements closer together to ultimately produce the desired spacing for playback while curved. This relationship (record closer to normal to accommodate stretching, further from normal to accommodate shrinkage) can be implementation-specific and a person of skill in the art of holography will appreciate that different implementations (e.g., different recording set ups and hologram properties) may different relationships. However, returning to method 100, in general optically recording a hologram in the holographic film while the holographic film is in the planar geometry per 102 may include optically recording the hologram in the holographic film with a first laser at a first incidence angle while the holographic film is in the planar geometry, the first incidence angle different from a playback incidence angle of the curved HOE.

Methods 100 and 400 each produce a curved HOE by optically recording a hologram into holographic film while the holographic film is in a planar geometry and then subsequently applying a curvature to the holographic film. Because the curvature is applied after recording the hologram, methods 100 and 400 provide various methods of compensating (e.g., convergence compensation, wavelength compensation) for effects that the applied curvature will have on the initially planar hologram. Furthermore, physically deforming the holographic film once a hologram is recorded therein/thereon (i.e., in applying curvature to the holographic film at 103/403) can adversely affect the interference pattern of the hologram (and thereby adversely affect the playback performance of the hologram). In order to mitigate such effects, it may be advantageous to ensure that curvature is applied to the holographic film (i.e., at 103/403) very gently and/or slowly and to control other factors such as temperature and pressure. In some implementations, it can be advantageous to cool the holographic film after optical recording of the hologram (i.e., after 102/402) but before (and/or during) applying curvature to the holographic film (i.e., at 103/403) in order to at least partially “freeze” the interference pattern in place in the holographic film and reduce physical deformations thereof. In other implementations, it can be advantageous to heat the holographic film after optical recording of the hologram (i.e., after 102/402) but before (and/or during) applying curvature to the holographic film (i.e., at 103/403) in order to at least partially increase the malleability of the holographic film and the interference pattern therein/thereon prior to applying physical deformations thereto.

In accordance with the present systems, devices, and methods, an alternative to methods 100 and 400 is to optically record the hologram while the holographic film is already in a curved configuration.

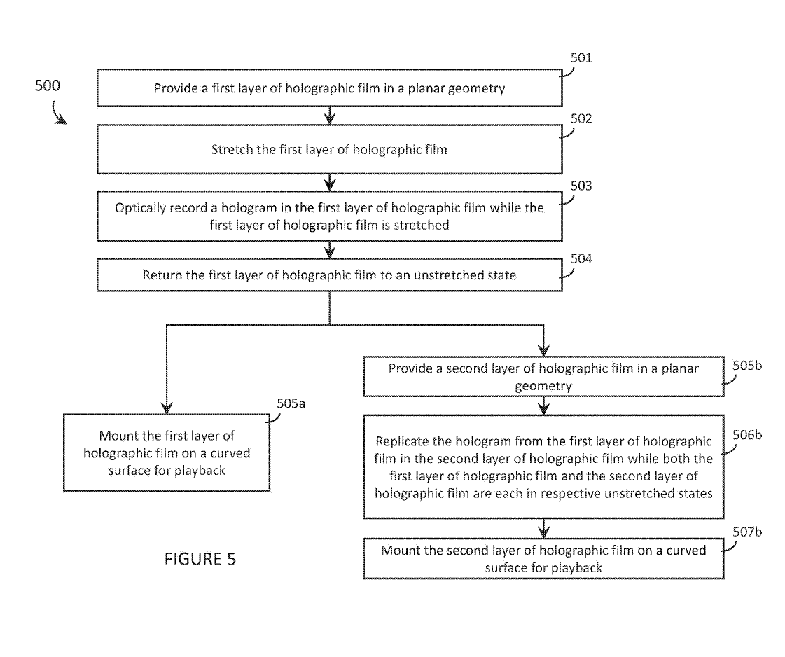

FIG. 5 is a flow-diagram showing an exemplary method 500 of producing a HOE that comprises at least one hologram recorded in a holographic film in accordance with the present systems, devices, and methods. Method 500 includes four basic acts 501, 502, 503, and 504 and then a branch to two different scenarios depending on the implementation. Scenario A comprises one act 505a in addition to acts 501, 502, 503, and 504 while scenario B comprises three acts 505b, 506b, and 507b in addition to acts 501, 502, 503, and 504. Those of skill in the art will appreciate that in alternative embodiments certain acts may be omitted and/or additional acts may be added. Those of skill in the art will also appreciate that the illustrated order of the acts is shown for exemplary purposes only and may change in alternative embodiments.

At 501, a first layer of holographic film is provided in a planar geometry. The holographic film is unrecorded and advantageously not exposed to light in order to prevent unwanted impressions in the film.

At 502, the first layer of holographic film is stretched. Stretching the first layer of holographic film may include applying a curvature to the holographic film such that it is no longer planar, which may include mounting the first layer of holographic film onto a curved transparent surface. Mounting the first layer of holographic film onto a curved transparent surface may employ similar techniques to act 101 of method 100 and/or act 401 of method 400 (where the holographic film is mounted on a planar transparent surface) with the obvious distinction that the transparent surface is curved in method 500 whereas the transparent surface is planar in methods 100 and 400. Alternatively, stretching the first layer of holographic film may include applying a curvature to the first layer of holographic film by using various techniques for film forming/shaping, such as by positioning the first layer of holographic film as a membrane across a pressure differential.

At 503, a hologram is optically recorded in the first layer of holographic film while the first layer of holographic film is in the stretched state of 502. Depending on the nature of the hologram, optically recording the hologram in the first layer of holographic film while the first layer of holographic film is in the stretched state (i.e., while the first layer of holographic film is curved) may require compensating for an optical effect of a curved transparent surface upon which the holographic film is mounted if the holographic film is mounted on a curved transparent surface.

At 504, the first layer of holographic film is returned to an unstretched state. Returning the first layer of holographic film to the unstretched state may include relaxing or otherwise removing the stretching force applied at 502. If the holographic film is mounted on a curved transparent surface at 502 then returning the first layer of holographic film to the unstretched state at 504 may include removing (e.g., delaminating) the holographic film from the curved transparent surface. As described previously, once a hologram with an associated interference pattern is recorded in/on a holographic film, it can be advantageous to cool/heat (depending on the implementation) the holographic film prior to applying physical deformations thereto (i.e., returning from the stretched state of 502 and 503 to an unstretched state at 504) in order to mitigate any damage such physical deformations may inflict on the interference pattern of the hologram.

After act 504, the HOE is in an unstretched, planar geometry but carries a hologram that was recorded while the HOE was in a stretched and/or curved geometry. That is, the HOE is planar and unstretched but the hologram is designed to be played back while the HOE is curved and stretched. From 504 method 500 proceeds in one of two directions depending on whether the first layer of holographic film will be played back itself (scenario A) or the first layer of holographic film will be used as a master to produce one or more copies using hologram replication techniques (scenario B).

When the first layer of holographic film will be played back itself (scenario A), method 500 proceeds from act 504 to act 505a.

At 505a, the first layer of holographic film is mounted on a curved surface for playback or embedded within a curved volume for playback. The curved surface/volume may be whatever curved surface/volume upon or within which the HOE is intended to be used in its curved geometry. As an example, the curved surface/volume may be a surface/volume of an eyeglass lens in a VRD architecture as described previously. If the curved surface is a surface of an eyeglass lens, the curved surface may be an inner surface (typically concave in curvature) or an outer surface (typically convex in curvature) of the eyeglass lens. Mounting the first layer of holographic film on the curved surface and/or embedding the first layer of holographic film within the curved volume may include, for example, techniques described in U.S. Provisional Patent Application Ser. No. 62/214,600 (now U.S. Non-Provisional patent application Ser. No. 15/256,148). Mounting the first layer of holographic film on the curved surface or embedding the first layer of holographic material within the curved volume may include stretching the first layer of holographic film in the direction normal to the plane of the first layer of holographic film onto the curved surface or within the curved volume in order to produce substantially the same geometry that was previously produced at 502 of method 500 and used during optical recording of the hologram at 503.

When the first layer of holographic film will be used as a master to produce one or more copies using hologram replication techniques (scenario B), method 500 proceeds from act 504 to acts 505b, 506b, and 507b.

At 505b, a second layer of holographic film is provided in a planar geometry. The second layer of holographic film is unrecorded and advantageously not exposed to light in order to prevent unwanted impressions in the film.

At 506b (which retains the “b” label even though there is no corresponding “506a” in order to clarify that a “506^{th} act” is only performed in scenario B), the hologram from the first layer of holographic film is replicated in the second layer of holographic film while both the first layer of holographic film and the second layer of holographic film are in respective unstretched states. This replication is completed using established techniques for replicating either surface relief holograms or volumetric holograms depending on the nature of the hologram. Generally, the first layer of holographic film and the second layer of holographic film are pressed together and the hologram from the first layer of holographic film is either physically/mechanically embossed, debossed, stamped, or otherwise impressed into the second layer of holographic film and/or the hologram in the first layer of holographic film may function like a mask and substantially the same interference pattern may be optically recorded into the second layer of holographic film through the first layer of holographic film.

At 507b (which likewise retains the “b” label even though there is no corresponding “507a” in order to clarify that a “507^{th} act” is only performed in scenario B), the second layer of holographic film is mounted on a curved surface or embedded in a curved volume for playback in a substantially similar way to that described for the first layer of holographic film at 505a under scenario A of method 500.

When the first layer of holographic film is used as a master to produce one or more copies using hologram replication techniques under scenario B of method 500, the first layer of holographic film may be used to produce any number of copies (i.e., any number of “second layers of holographic film”) via hologram replication techniques.

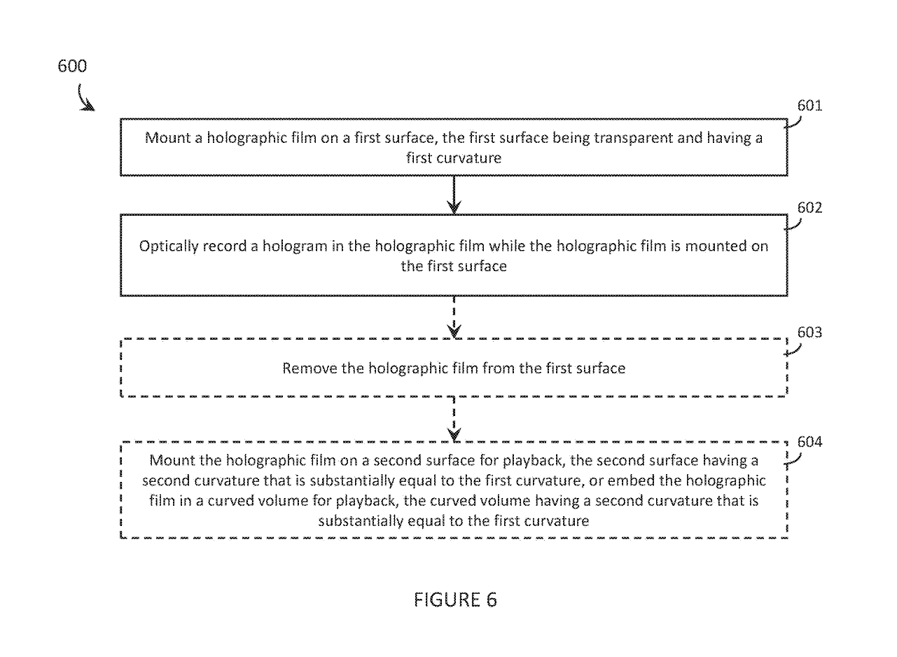

FIG. 6 is a flow-diagram showing an exemplary method 600 of producing a curved HOE in accordance with the present systems, devices, and methods. Method 600 includes two basic acts 601 and 602 and two optional acts 603 and 604, though those of skill in the art will appreciate that in alternative embodiments certain acts may be omitted and/or additional acts may be added. Those of skill in the art will also appreciate that the illustrated order of the acts is shown for exemplary purposes only and may change in alternative embodiments.

At 601, a holographic film is mounted on a first surface, the first surface being transparent and having a first curvature. The first curvature may be concave or convex depending on the particular implementation. The holographic film may be mounted on the first surface using any of a variety of different techniques, including without limitation: lamination, adhesion, gluing, mechanical support fixtures, static, friction, an interference fit, pressure points, stretching, compressing/constricting/squashing, and so on. Act 601 of method 600 may, in some implementations, be substantially similar to act 502 of method 500.

At 602, a hologram is optically recorded in the holographic film while the holographic film is mounted on the first surface. In other words, a hologram is optically recorded in the holographic film while the holographic film is curved. As described previously, optically recording a hologram through a curved transparent surface may require that any optical effects of the curved transparent surface (e.g., lensing effects, refraction effects, and so on) be taken into account and compensated for in the recording light pattern(s). Optically recording a curved hologram can also significantly impact the range of angles from which the recording light is incident (and likewise from which the playback light will be incident); thus, it is advantageous to ensure that the resulting hologram has sufficient angular bandwidth to accommodate this potentially wider range of incident angles. The hologram bandwidth can be controlled, at least in part, with the material properties of the holographic film. For example, a thinner layer of holographic film generally has a wider angular bandwidth than a thicker layer of holographic film. Act 602 of method 600 may, in some implementations, be substantially similar to act 503 of method 500.

In some implementations, the first surface upon which the holographic film is mounted at 601 and upon which the hologram is optically recorded in the holographic film at 602 may be the surface upon which the HOE is ultimately used during playback. For example, if the HOE is for use on a curved eyeglass lens in the VRD architecture described previously, then the first surface upon which the holographic film is mounted at 601 may be a surface of the eyeglass lens itself. That is, at 601 the holographic film may be mounted on a surface of an eyeglass lens and at 602 a hologram may be optically recorded in the holographic film while the holographic film is mounted on the surface of the eyeglass lens. In such implementation, method 600 concludes after act 602.

In other implementations, the first surface upon which the holographic film is mounted at 601 and upon which the hologram is optically recorded in the holographic film at 602 may be a temporary surface used only for the optical recording phase at 602. In such implementations, method 600 proceeds from act 602 to acts 603 and 604.

At 603, the holographic film is removed from the first surface. In some implementations, it may be advantageous to enhance the rigidity of the holographic film before it is removed from the first surface in order to facilitate preservation of the first curvature in the hologram. The rigidity may be enhanced by, for example: cooling the holographic film prior to removal from the first surface and/or applying a hardening agent to the holographic film and curing/setting this hardening agent before removing the holographic film from the first surface. In other implementations, the holographic film may return to a substantially planar configuration when removed from the first surface at 603.

At 604, the holographic film is mounted on a second surface or embedded within a curved volume for playback, the second surface/curved volume having a second curvature that is substantially equal to the first curvature. The holographic film may be mounted on the second surface at 604 in a substantially similar way to how the holographic film is mounted on the first surface at 601, with the noted distinction that (in implementations when method 600 proceeds beyond act 602 to acts 603 and 604) at 601 the holographic film is mounted temporarily on the first surface and at 604 the holographic film is mounted permanently on the second surface. Hardening or otherwise increasing the rigidity of the holographic film before removal from the first surface at 603 may advantageously facilitate mounting the holographic film on the second surface or embedding the holographic film within a curved volume at 604. The second surface upon, or the curved surface within, which the holographic film is mounted/embedded at 604 may be the surface/volume upon/within which the HOE is ultimately used during playback. For example, if the HOE is for use on or within a curved eyeglass lens in the VRD architecture described previously, then the second surface upon, or curved volume within, which the holographic film is mounted/embedded at 604 may be a surface/volume of an eyeglass lens.

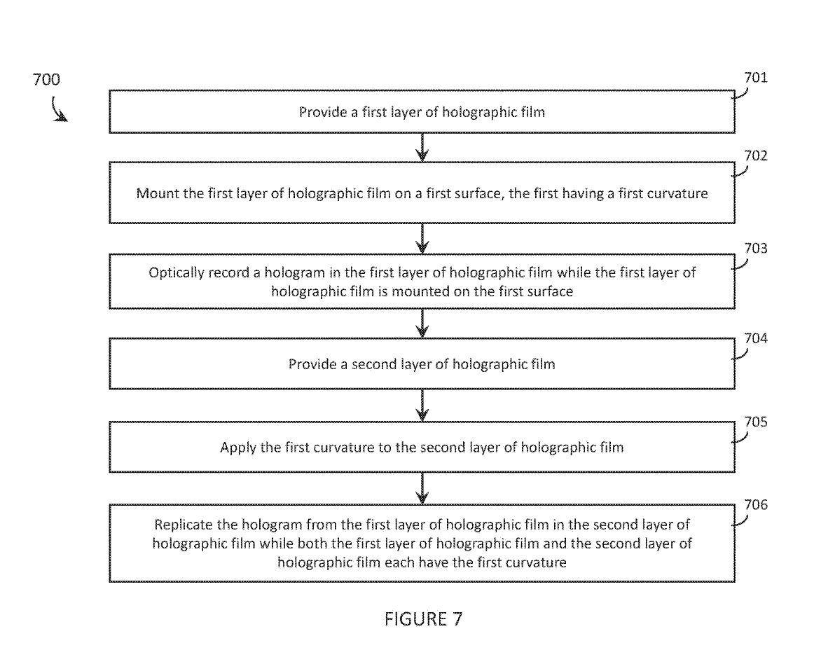

FIG. 7 is a flow-diagram showing an exemplary method 700 of replicating a curved HOE that comprises at least one hologram recorded in a holographic film in accordance with the present systems, devices, and methods. Method 700 includes six acts 701, 702, 703, 704, 705, and 706, though those of skill in the art will appreciate that in alternative embodiments certain acts may be omitted and/or additional acts may be added. Those of skill in the art will also appreciate that the illustrated order of the acts is shown for exemplary purposes only and may change in alternative embodiments.

At 701, a first layer of holographic film is provided. The first layer of holographic film is unrecorded and advantageously not exposed to light in order to prevent unwanted impressions in the film.

At 702, the first layer of holographic film is mounted on a first surface, the first surface being transparent and having a first curvature. Act 702 of method 700 may be substantially similar to act 601 of method 600 and/or act 502 of method 500.

At 703, a hologram is optically recorded in the first layer of holographic film while the first layer of holographic film is mounted on the first surface. That is, a hologram is optically recorded in the first layer of holographic film while the first layer of holographic film is mounted on a transparent curved surface. Act 703 of method 700 may be substantially similar to act 602 of method 600 and/or act 503 of method 500.

At 704, a second layer of holographic film is provided. The second layer of holographic film is unrecorded and advantageously not exposed to light in order to prevent unwanted impressions in the film.

At 705, the first curvature (i.e., the curvature of the first surface upon which the first layer of holographic film is mounted) is applied to the second layer of holographic film. The first curvature may be applied to the second layer of holographic film by, for example: mounting the second layer of holographic film on a second surface that has a curvature substantially similar to the first curvature; by mounting the second layer of holographic film on or under the first layer of holographic film either on the first surface or on a second surface of the same structure that includes the first surface, the second surface opposite the first surface on the same structure; or by embedding the second layer of holographic film within a curved volume that has a curvature substantially similar to the first curvature. In some implementations, the first layer of holographic film may be removed from the first surface in a way substantially similar to that described at 603 of method 600 and the first layer of holographic film and the second layer of holographic film may be combined on a surface or structure that retains the first curvature.

At 706, the hologram from the first layer of holographic film is replicated in the second layer of holographic film while both the first layer of holographic film and the second layer of holographic film each have the first curvature. That is, the techniques for holographic replication that are typically employed using planar layers of holographic film are adapted for use with two substantially similarly curved layers of holographic film. The replication may use a mechanical/physical stamping/embossing/debossing/impressing process to physically copy the features of the hologram from the first layer of holographic film into the second layer of holographic film while both the first layer of holographic film and the second layer of holographic film exhibit the first curvature, in which case the conventionally-planar hologram replication process may be adapted to employ a curved press/stamp having the first curvature and/or a mating curved “bowl and press” (e.g., mortar and pestle) combination having mating concave and convex versions of the first curvature. The replication may use optical recording in which the first layer of holographic film over/underlies the second layer of holographic film and the hologram in the first layer of holographic serves as an optical mask for recording the same interference pattern into the second layer of holographic film.

FIGS. 1, 3, 4, 5, 6, and 7 all describe various processes (100, 300, 400, 500, 600, and 700, respectively) of producing curved HOE products, any or all of which may be used, as an example, in the VRD architecture described previously. Generally, the processes for making/replicating curved HOEs described herein may produce curved HOE products and, accordingly, the scope of the present systems, devices, and methods includes curved HOE products that are prepared by processes comprising the acts of the various methods (e.g., method 100, method 400, method 500, method 600, and/or method 700) described herein.

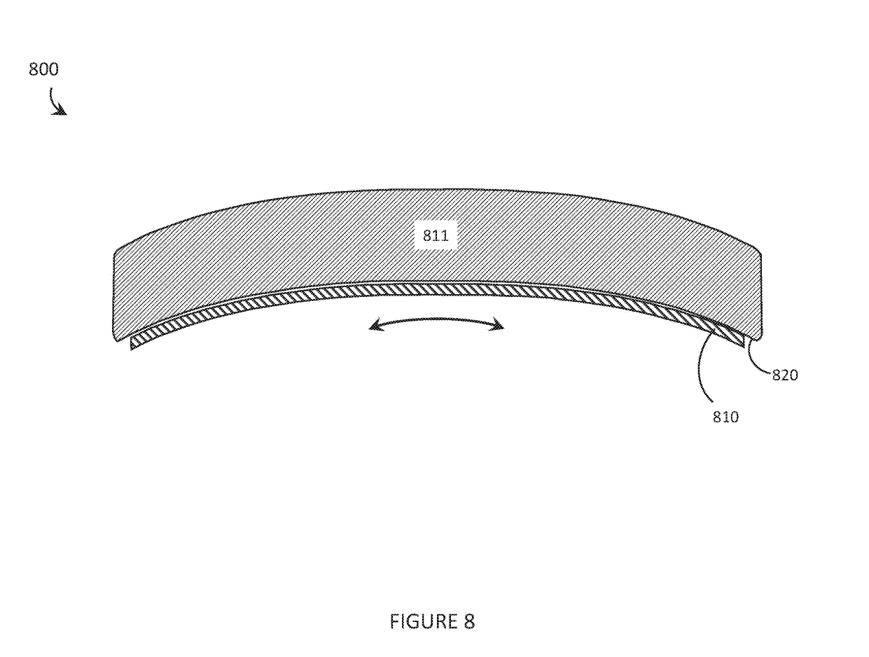

FIG. 8 is a sectional view of an exemplary curved HOE 800 in accordance with the present systems, devices, and methods. Curved HOE 800 includes a layer of holographic film 810 mounted on a transparent curved surface 820 (having a first curvature emphasized by the arrows in FIG. 8) of a transparent substrate 811 and may be prepared by any of method 100, 300, 400, 500, 600, and/or 700. In the illustrated example, substrate 811 is an eyeglass lens and curved HOE 800 forms a transparent combiner for use in a VRD architecture as described previously.

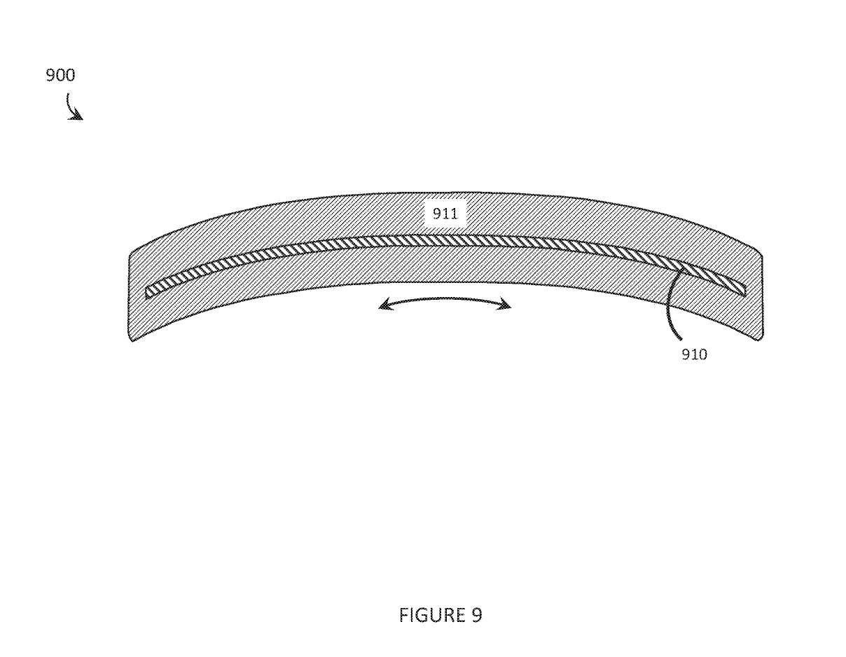

FIG. 9 is a sectional view of another exemplary curved HOE 900 in accordance with the present systems, devices, and methods. Curved HOE 900 includes a layer of holographic film 910 embedded within a curved volume 911 (having a first curvature emphasized by the arrows in FIG. 9) and may be prepared by any of method 100, 300, 400, 500, 600, and/or 700. In the illustrated example, curved volume 911 is an eyeglass lens and curved HOE 900 forms a transparent combiner for use in a VRD architecture as described previously. Curved HOE 900 has a total optical power P_{T}. The embedded layer of holographic film 910 includes at least one hologram having a holographic optical power P_{H} that is less than the total optical power P_{T} of curved HOE 900. The curvature of layer of holographic film 910 also has a geometric optical power P_{G} that is less than the total optical power P_{T} of curved HOE 900. The total optical power P_{T} of curved HOE 900 includes an additive combination of the holographic optical power P_{H} of the at least one hologram and the geometric optical power P_{G} of the curved layer of holographic film 911 given, at least approximately, by P_{T}=P_{H}+P_{G}.

The total optical power P_{T} of curved HOE 900 is positive and has a total focal length f_{T}. The holographic optical power P_{H} of the at least one hologram is positive and has a first focal length f_{H} that is greater than the total focal length f_{T} of curved HOE 900. The geometric optical power P_{G} of the curved layer of holographic film 910 is positive and has a second focal length f_{G} that is greater than the total focal length f_{T} of curved HOE 900. The total focal length f_{T} of curved HOE 900 includes an additive reciprocal combination of the first focal length f_{H} and the second focal length f_{G} given, at least approximately, by 1/f_{T}=1/f_{H}+1/f_{G}.

Various embodiments described herein apply stretching to a holographic film in order to induce curvature. Such stretching can alter the thickness of the holographic film which, as previously described, can impact the angular bandwidth of the hologram (i.e., the range of angles of incidence over which the hologram will play back). In accordance with the present systems, devices, and methods, it can be advantageous to accommodate the changes in thickness that may result when curvature is applied to a holographic film by starting with a planar thickness of holographic film that is different from the intended curved thickness of the holographic film so that the change in thickness brought on by the curvature will result in the desired curved thickness of the holographic film. For example, if the holographic film is going to be curved by stretching, the planar thickness of the holographic film may advantageously be larger than the intended curved thickness so that the thickness reduction that results during stretching will produce the intended curved thickness.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” to, at least, provide,” “to, at least, transmit,” and so on.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other portable and/or wearable electronic devices, not necessarily the exemplary wearable electronic devices generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors, central processing units, graphical processing units), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any processor-readable medium for use by or in connection with any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “non-transitory processor-readable medium” can be any element that can store the program associated with logic and/or information for use by or in connection with the instruction execution system, apparatus, and/or device. The processor-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other non-transitory media.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet which are owned by Thalmic Labs Inc., including but not limited to: U.S. Provisional Patent Application Ser. No. 62/268,892, U.S. Non-Provisional patent application Ser. No. 15/381,883, U.S. Provisional Patent Application Ser. No. 62/242,844 (now U.S. Non-Provisional patent application Ser. No. 15/147,638), U.S. Provisional Patent Application Ser. No. 62/156,736 (now U.S. Non-Provisional patent application Ser. No. 15/145,576, US Patent Application Publication No. 2016-0327797, and US Patent Application Publication No. 2016-0327796), U.S. Provisional Patent Application Ser. No. 62/117,316 (now U.S. Non-Provisional patent application Ser. No. 15/046,234, U.S. Non-Provisional patent application Ser. No. 15/046,254, and US Patent Application Publication No. 2016-0238845), and U.S. Provisional Patent Application Ser. No. 62/214,600 (now U.S. Non-Provisional patent application Ser. No. 15/256,148), are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of producing a curved holographic optical element (“HOE”), the method comprising:
mounting a holographic film on a first surface, the first surface being transparent and having a first curvature; and
optically recording a hologram in the holographic film while the holographic film is mounted on the first surface.

2. The method of claim 1, further comprising:
removing the holographic film from the first surface; and at least one of:
mounting the holographic film on a second surface for playback, the second surface having a second curvature substantially equal to the first curvature; or
embedding the holographic film within a curved volume for playback, the curved volume having a second curvature substantially equal to the first curvature.

3. A method of replicating a curved holographic optical element (“HOE”) that comprises at least one hologram recorded in a holographic film, the method comprising:
providing a first layer of holographic film;
mounting the first layer of holographic film on a first surface, the first surface having a first curvature;
optically recording a hologram in the first layer of holographic film while the first layer of holographic film is mounted on the first surface;
providing a second layer of holographic film;
applying the first curvature to the second layer of holographic film; and
replicating the hologram from the first layer of holographic film in the second layer of holographic film while both the first layer of holographic film and the second layer of holographic film each have the first curvature.
